(19) United States
(12) Patent Application Publication
(10) Pub. No.: US 2026/0225619 A1
(43) Pub. Date: Aug. 6, 2026

(54) METHOD AND VEHICLE FOR RECOGNIZING IRREGULAR STATIC OBJECT FOR IDENTIFICATION OF ROAD BOUNDARY

(71) Applicants: HYUNDAI MOTOR COMPANY, Seoul (KR); KIA CORPORATION, Seoul (KR)

(72) Inventors: Hye Rim LEE, Hwaseong-si (KR); Kyeong Jin JEON, Hwaseong-si (KR); Keon Woo JANG, Hwaseong-si (KR)

(21) Appl. No.: 19/455,117

(22) Filed: Jan. 21, 2026

(30) Foreign Application Priority Data
Feb. 5, 2025 (KR) 10-2025-0014391

(51) Int. Cl. B60W 60/00; B60W 50/00; G01S 13/89; G01S 13/931

(52) U.S. Cl. CPC B60W 60/0015; B60W 50/0097; G01S 13/89; G01S 13/931; B60W 2420/408; B60W 2552/53; B60W 2554/20; B60W 2556/45; G01S 2013/9323

(57) ABSTRACT

Disclosed is a method and vehicle for recognizing irregular static object for identification of road boundary. The method may include generating, based on point cloud data generated by a sensor of the vehicle, a plurality of tracked positions of static objects that are arranged serially; determining a prediction range that is spaced apart from a preceding tracked position of the plurality of tracked positions; adding, based on detecting a next tracked position within the prediction range, the next tracked position to a tracking list; identifying, based on the tracking list including at least a threshold quantity of tracked positions, the plurality of tracked positions as a road boundary including successive static objects; and controlling, based on the identified road boundary, an autonomous driving operation of the vehicle.

### CROSS-REFERENCE TO RELATED APPLICATION

This application claims the benefit of and priority to Korean Patent Application No. 10-2025-0014391, filed Feb. 5, 2025 in the Korean Intellectual Property Office, the disclosure of which is incorporated herein by reference in its entirety.

### FIELD OF TECHNOLOGY

The present disclosure relates to autonomous vehicles, and more particularly to road boundary identification.

### BACKGROUND

Modern vehicles are equipped with various functions for driving convenience. For example, an autonomous driving function may allow vehicles to operate with little to no control from a human operator.

The vehicle may perceive a surrounding environment by obtaining information from various types of heterogeneous sensors, and identify a situation around the vehicle based on the perceived surrounding environment. The vehicle may establish a control plan for autonomous driving corresponding to the identified situation to control one or more actuators of the vehicle.

The perceived surroundings may include, for example, dynamic objects and static objects. The static objects may include roads and stationary objects around the roads. The static objects, for example, may include road safety facilities, road signs, and lanes that are considered for driving on the roads. The road safety facilities (also referred to as road safety items, road safety equipment, traffic safety equipment, etc.) may represent road boundaries and may include, for instance, facility guide posts, traffic cones, traffic barrels, curbs, bollards, sandbags, and the like.

Types and attributes of dynamic objects and other static objects may be identified via bounding areas by perception (e.g., visual machine recognition) of the objects based on sensor data that detects the surrounding environment. The sensor data may be output from, for example, a radar sensor or a lidar sensor. Although a type of a single road safety item may be identified by perception of the object, attributes or functions of multiple road safety facilities (e.g., a series of road safety items) that are successively arranged on the road may not be clearly identified by perception via the sensor data. Specifically, whether the road safety facilities in the successive arrangement have attributes of road boundaries sometimes may not be correctly inferred by perception based on the sensor data. Here, the road safety facilities arranged in the successive arrangement may be a type of an irregular static object in which a bounding area that identifies a function may not be correctly identified by visual recognition.

Accordingly, the vehicle may incorrectly determine the space between the road safety facilities that are placed at an interval as a drivable area instead of recognizing the space as part of a road boundary. Such determination may lead to an error in vehicle control.

The matters described in this Background section are only for enhancement of understanding of the background of the disclosure, and should not be taken as acknowledgement that they correspond to prior art already known to those skilled in the art.

### SUMMARY

The various aspects of the present disclosure is to provide a method and vehicle for recognizing an irregular static object that accurately provides the road boundary by estimating a function on the road intended by the irregular static objects arranged successively.

The various aspects to be achieved by the present disclosure are not limited to the above-mentioned technical problems, and other technical problems that are not mentioned will be clearly understood by those skilled in the art to which the present disclosure belongs from the description below.

According to one or more example embodiments of the present disclosure, a method performed by an apparatus of a vehicle may include: generating, based on point cloud data generated by a sensor of the vehicle, a plurality of tracked positions of static objects that are arranged serially; determining a prediction range that is spaced apart from a preceding tracked position of the plurality of tracked positions; adding, based on detecting a next tracked position within the prediction range, the next tracked position to a tracking list; identifying, based on the tracking list including at least a threshold quantity of tracked positions, the plurality of tracked positions as a road boundary including successive static objects; and controlling, based on the identified road boundary, an autonomous driving operation of the vehicle.

The prediction range may include an enclosed area arranged at a distance away from the preceding tracked position.

Adding the next tracked position may include: adding, to the tracking list, the next tracked position that is detected in the enclosed area.

The enclosed area may be positioned at an angle, relative to the preceding track position, within a predetermined angular range. The predetermined angular range may be determined based on a direction in which the preceding tracked position and the next tracked position are arranged.

The threshold quantity may be at least three.

The method may further include: determining prediction ranges and adding next tracked positions repeatedly for a plurality of subsequent tracked positions. Identifying the plurality of tracked positions as the road boundary may include: removing, based on presence of a duplicate tracked position in the tracking list, the duplicate tracked position from the tracking list; and identifying remaining tracked positions in the tracking list as the road boundary.

The method may further include: based on detecting no tracked position within a first prediction range and detecting respective tracked positions in a second prediction range and a third prediction range, adding, to the tracking list, the respective tracked positions in the second prediction range and the third prediction range. The first prediction range, the second prediction range, and the third prediction range may be consecutive prediction ranges that are spaced apart from each other.

The method may further include: based on detecting no tracked positions within three consecutive prediction ranges that are spaced apart from each other, classifying the three consecutive prediction ranges as non-successive static objects in the road boundary.

The static objects may include traffic safety equipment.

According to one or more example embodiments of the present disclosure, a method performed by an apparatus of a vehicle may include: generating, based on point cloud data generated by a sensor of the vehicle, a plurality of tracked positions of static objects that are arranged serially; generating, based on a spatial relationship between a leading tracked position and a trailing tracked position of the plurality of tracked positions, a linear model; based on an intermediate tracked position having linear correlation above a threshold value, with respect to the leading tracked position and the trailing tracked position, and based on sensor characteristics of the plurality of tracked positions having at least a threshold similarity value, identifying, the plurality of tracked positions as a road boundary including successive static objects; and controlling, based on the identified road boundary, an autonomous driving operation of the vehicle. The intermediate tracked position may be between the leading tracked position and the trailing tracked position.

The sensor may include at least one of: a radar sensor or a lidar sensor. The sensor characteristics associated with the radar sensor may include at least one of: a signal-to-noise ratio or a radar cross section. The sensor characteristics associated with the lidar sensor may include an intensity of a reflected signal.

According to one or more example embodiments of the present disclosure, a vehicle may include: a sensor configured to generate, based on a surrounding environment of the vehicle, point cloud data; a processor; and a memory storing at least one instruction that is configured, when executed by the processor, to cause the vehicle to: generate, based on the point cloud data, a plurality of tracked positions of static objects that are arranged serially; determine a prediction range that is spaced apart from a preceding tracked position of the plurality of tracked positions; add, based on detecting a next tracked position within the prediction range, the next tracked position to a tracking list; identify, based on the tracking list including at least a threshold quantity of tracked positions, the plurality of tracked positions as a road boundary including successive static objects; and control, based on the identified road boundary, an autonomous driving operation of the vehicle.

The prediction range may include an enclosed area arranged at a distance away from the preceding tracked position.

The at least one instruction may be configured, when executed by the processor, to cause the vehicle to add the next tracked position by: adding, to the tracking list, the next tracked position that is detected in the enclosed area.

The enclosed area may be positioned at an angle, relative to the preceding track position, within a predetermined angular range. The predetermined angular range may be determined based on a direction in which the preceding tracked position and the next tracked position are arranged.

The threshold quantity may be at least three.

The at least one instruction may be configured, when executed by the processor, to further cause the vehicle to determine prediction ranges and add next tracked positions repeatedly for a plurality of subsequent tracked positions. The at least one instruction may be configured, when executed by the processor, to cause the vehicle to identify the plurality of tracked positions as the road boundary by: removing, based on presence of a duplicate tracked position in the tracking list, the duplicate tracked position from the tracking list; and identifying remaining tracked positions in the tracking list as the road boundary.

The at least one instruction may be configured, when executed by the processor, to further cause the vehicle to: based on detecting no tracked position within a first prediction range and detecting respective tracked positions in a second prediction range and a third prediction range, add, to the tracking list, the respective tracked positions in the second prediction range and the third prediction range. The first prediction range, the second prediction range, and the third prediction range may be consecutive prediction ranges that are spaced apart from each other.

The at least one instruction may be configured, when executed by the processor, to further cause the vehicle to: based on detecting no tracked positions within three consecutive prediction ranges that are spaced apart from each other, classify the three consecutive prediction ranges as non-successive static objects in the road boundary.

The static objects may include traffic safety equipment.

### BRIEF DESCRIPTION OF THE DRAWINGS

The above and other objects, features and advantages of the present disclosure will become more apparent to those of ordinary skill in the art by describing one or more example embodiments thereof in detail with reference to the accompanying drawings, in which:

FIG. 1 is a diagram illustrating an example vehicle communicating with another device to transmit and receive data.

FIG. 2 is a diagram illustrating example modules that constitute a vehicle.

FIG. 3 is a diagram illustrating an example traffic safety facility.

FIG. 4 is a diagram illustrating example modules that constitute a server.

FIG. 5 is a flowchart of an example method for recognizing an irregular static object for identification of a road boundary.

FIGS. 6A, 6B, and 6C are diagrams illustrating examples of a search for a tracked location.

FIGS. 7A, 7B, and 7C are diagrams illustrating examples of the search for the tracked location.

FIGS. 8A, 8B, 8C, and 8D are diagrams illustrating examples of the search for the tracked location.

FIG. 9 is a flowchart of an example method for recognizing an irregular static object for identification of a road boundary.

FIGS. 10A and 10B are diagrams illustrating examples of the search for the tracked location.

### DETAILED DESCRIPTION

Hereinafter, one or more example embodiments of the present disclosure will be described in detail with reference to the accompanying drawings so that those skilled in the art may easily implement the present disclosure. However, the present disclosure may be implemented in various different ways, and is not limited to the example embodiment(s) described therein.

In describing example embodiment(s) of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms “first,” “second,” etc. are only used to distinguish one element from another and do not limit the order or the degree of importance between the elements unless specifically mentioned. Accordingly, a first element in one example embodiment could be termed a second element in another example embodiment, and, similarly, a second element in one example embodiment could be termed a first element in another example embodiment, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality (e.g., serially, in a row, etc.) of hardware or software units. Therefore, even if not mentioned otherwise, such integrated or distributed embodiment(s) are included in the scope of the present disclosure.

In the present disclosure, elements described in various example embodiment(s) do not necessarily mean essential elements, and some of them may be optional elements. Therefore, an embodiment composed of a subset of elements described in an example embodiment is also included in the scope of the present disclosure. In addition, example embodiment(s) including other elements in addition to the elements described in the various example embodiments are also included in the scope of the present disclosure.

The advantages and features of the present disclosure and the way of attaining them will become apparent with reference to one or more example embodiments described below in detail in conjunction with the accompanying drawings. The present disclosure, however, may be embodied in many different forms and should not be constructed as being limited to example embodiment(s) set forth herein. Rather, these example embodiment(s) are provided so that this disclosure will be complete and will fully convey the scope of the disclosure to those skilled in the art.

In the present disclosure, each of phrases such as “A or B”, “at least one of A and B”, “at least one of A or B”, “A, B or C”, “at least one of A, B, and C”, “at least one of A, B, or C,” “at least one of A, B, C or any combination thereof,” etc. may include any one or all possible combinations of the items listed together in the corresponding one of the phrases. For example, for purposes of the present application and the claims, using the exemplary phrase “at least one of: A; B; or C” or “at least one of A, B, or C,” the phrase means “at least one A, or at laest one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In the present disclosure, expressions of location relations used in the present specification such as “upper,” “lower,” “left,” and “right” are employed for the convenience of explanation, and in case drawings illustrated in the present specification are inversed, the location relations described in the specification may be inversely understood.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., identifying a road boundary based on serially arranged static objects) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., identifying a road boundary based on serially arranged static objects) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., identifying a road boundary based on serially arranged static objects) described herein.

Minimum risk maneuver (MRM) operation(s) may also be controlled, for example, based on one or more features (e.g., identifying a road boundary based on serially arranged static objects) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., identifying a road boundary based on serially arranged static objects) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

An autonomous driving level and/or autonomous driving activation/deactivation may also be controlled, for example, based on one or more features (e.g., identifying a road boundary based on serially arranged static objects) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as 5 seconds, 30 seconds, 1 minute, etc.). By changing the required user attentiveness, the driver may be required to look ahead more often (e.g., at least once in a threshold time period, such as 5 seconds, 30 seconds, 1 minute, etc.). By changing the autonomous driving level, one or more video contents may not be displayed on a display of the vehicle.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., identifying a road boundary based on serially arranged static objects) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD), engaging and/or disengaging an autonomous driving mode, etc.). One or more auxiliary devices (e.g., engine brake, exhaust brake, hydraulic retarder, electric retarder, regenerative brake, etc.) may also be controlled, for example, based on one or more features (e.g., identifying a road boundary based on serially arranged static objects) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., evaluating the engagement state of the driver) described herein.

The vehicle that an autonomous driving system is actively controlling may be referred to as an ego vehicle, a host vehicle, or an autonomous vehicle. The ego vehicle may also be referred to as a self-driving car, an autonomous car (AC), a driverless car, a robotaxi, a robotic car, or a robo-car. The ego vehicle may be the vehicle that is equipped with the autonomous driving system. Alternatively, the autonomous driving system may control the ego vehicle, for example, from an external and/or remote device, such as a server. The ego vehicle can be partially or wholly controlled (e.g., piloted, driven, etc.) remotely by a remote human driver. A car that is ahead of the ego vehicle (e.g., in the same driving lane as the ego vehicle) may be referred to as a vehicle in front (e.g., a vehicle directly in front), a vehicle ahead (e.g., a vehicle directly ahead), a lead vehicle, a leading vehicle, or a preceding vehicle. A car that follows the ego vehicle (e.g., in the same driving lane as the ego vehicle) may be referred to as a car behind, a trailing vehicle, a following vehicle, or a succeeding vehicle. An adjacent vehicle may refer to any vehicle located in any direction (e.g., front, rear, left, right, diagonal, etc.) from the ego vehicle as long as no other vehicles (e.g., intervening vehicles) exist between it and the ego vehicle (e.g., regardless of the distance from the ego vehicle). Alternatively, in some contexts, only those vehicles that are located within a threshold distance (e.g., line of sight and/or detection limit of one or more sensors of the ego vehicle) from the ego vehicle may be referred to as adjacent vehicles. A target vehicle may be any vehicle that is near the ego vehicle (e.g., within a threshold distance away from the ego vehicle). The target vehicle may be any vehicle that the autonomous driving system monitors, recognizes, identifies, tracks, and/or analyzes, either actively or passively, either once or multiple times, and either sporadically or continuously. The threshold distance may be, for example, the line of sight and/or the detection limit of one or more sensors of the ego vehicle, but the threshold distance may be a value (e.g., an adjustable value) that is less than the line of sight and/or the detection limit of the one or more sensors of the ego vehicle. The target vehicle can be, for example, a vehicle in front, a vehicle behind, a vehicle in a different lane than the driving lane of the ego vehicle (e.g., a vehicle to the left, a vehicle to the right, a vehicle in a diagonal direction, etc.), and/or an adjacent vehicle (e.g., regardless of the distance from the ego vehicle and/or regardless of whether there are intervening vehicle(s) between the target vehicle and the ego vehicle). A target vehicle may also be referred to as a surrounding vehicle, a nearby vehicle, an external vehicle, another vehicle (other vehicles), and so forth.

Hereinafter, one or more embodiments of the present disclosure will be described with reference to the accompanying drawings.

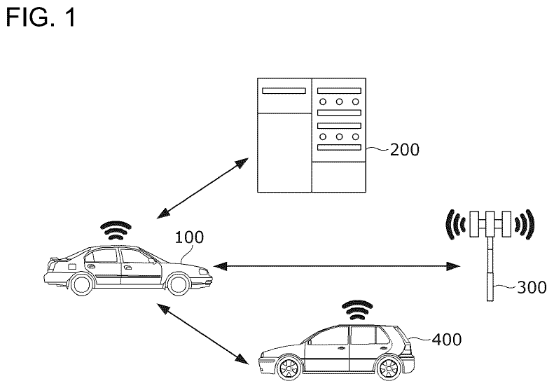

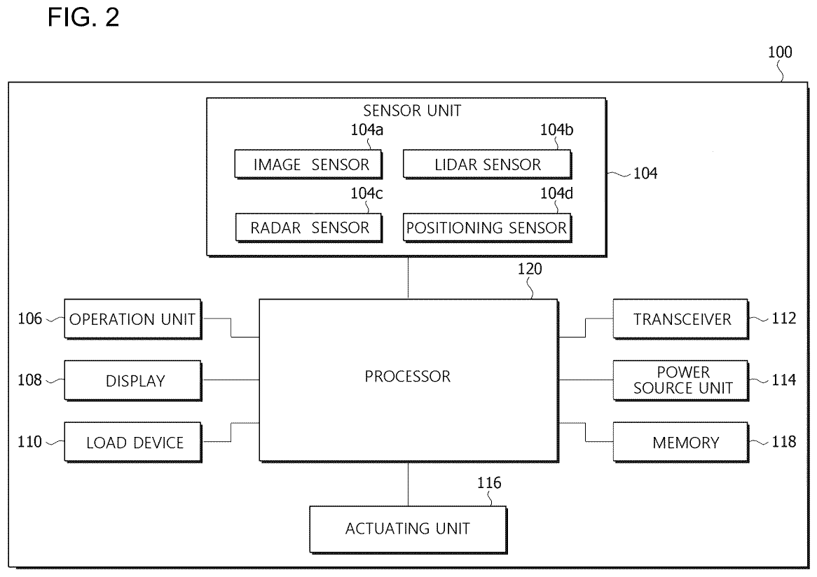

A vehicle that implements recognition of an irregular static object for identification of a road boundary will now be described with reference to FIGS. 1 and 2.

FIG. 1 is a diagram illustrating an example vehicle communicating with another device to transmit and receive data.

Referring to FIG. 1, a vehicle 100 may be driven based on electric energy or fossil energy. In the case of electric energy, the vehicle 100 may employ, for example, a pure battery-based vehicle driven only by a high-voltage battery or a gas-based fuel cell as an energy source. In addition, the fuel cell may use various types of gas capable of generating electric energy, and the gas may be filled into the vehicle 100 in a liquefied state, for example. Here, the gas may be hydrogen as an example. However, the gas is not limited thereto, and various gases may be applied. In the case of fossil energy, the vehicle 100 is driven by fuel such as gasoline, diesel, or liquefied gas, and may be equipped with an internal combustion engine that drives an actuating unit 116 by combustion of the fuel. The engine may be included in a power source unit 114 from the viewpoint of providing a driving rotational force of a wheel to a wheel driving unit 118. As another example, the vehicle 100 may drive the actuating unit 116 by selectively utilizing the energy of the fossil energy-based internal combustion engine and the electric battery, which may be a hybrid type vehicle.

The vehicle 100 may refer to a moveable device. The vehicle 100 is a ground vehicle that drives on the ground and may be a passenger or commercial vehicle, a purpose-built vehicle (PBV), or the like. The vehicle 100 may be a four-wheeled vehicle, such as a passenger car, an SUV, a small truck, or may be a vehicle with more than four wheels, such as a bus, a large truck, a container carrying vehicle, a heavy-equipment vehicle, and the like. The vehicle 100 may be a robot in a broad sense, such as a moving means, and the robot may be moved using wheels, tracks, or other moving modules. The examples described in the present disclosure may also be applied to robots, unless technically conflicted.

The vehicle 100 may be controlled to be driven by manual driving or autonomous driving due to the driving of a user. The autonomous driving may be implemented as semi-autonomous driving or fully autonomous driving. The fully autonomous driving may be provided as autonomous driving in which a processor 120 of the vehicle 100 completely controls without user intervention even if the driving situation is uncertain. The semi-autonomy driving may be provided by autonomous driving in which driver intervention is required according to a specific driving situation. The semi-self-driving may be implemented such that the processor 120 switches the control to the user while deactivating the autonomous driving if the above situation occurs, thereby causing the user to perform manual driving. According to the level of autonomous driving defined by the American Society of Automotive Engineers (SAE), the semi-autonomous driving may correspond to the autonomous driving levels 1 to 4, and the fully autonomous driving may correspond to level 5.

Meanwhile, the vehicle 100 may communicate with other devices 200 and 300 or another vehicle 400. The other devices may include, for example, a server 200 that supports various controls, state management, and driving of the vehicle 100, an intelligent transportation system (ITS) device 300 for receiving information from the ITS, various types of user devices, and the like. The server 200 is, for example, an external device operated by a vehicle manufacturer or provided for servicing a driving support function, and may receive connected data of the vehicle 100 or transmit data necessary for manual and autonomous driving. The server 200 may transmit various information and software modules used for controlling the vehicle 100 to the vehicle 100 in response to requests and data transmitted from the vehicle 100 and a user device, so as to support driving and various services of the vehicle 100.

The ITS device 300 is, for example, a Roadside Base Station (RSU), and the ITS device 300 may mutually exchange vehicle recognition data, driving control and state data, environmental data around the vehicle, map data, and the like via V2I with the vehicle 100 to assist the user in driving the own vehicle or support autonomous driving of the vehicle 100. In the present disclosure, the ITS device 300 may be referred to as a traffic infrastructure apparatus. The vehicle 100 may mutually exchange the above-listed data via V2V with the other vehicle 400 to support manual driving or autonomous driving.

The vehicle 100 may communicate with other vehicles or other devices based on cellular communication, Wireless Access in Vehicular Environment (WAVE) communication, Dedicated Short Range Communication (DSRC) or near field communication, or other communication schemes.

For example, the vehicle 100 may use a communication network such as LTE or 5G, a Wi-Fi communication network, a WAVE communication network, etc for communication with the server 200, the ITS device 300, and the other vehicle 400. As another example, a DSRC or the like used in the vehicle 100 may also be used for communication between vehicles. A communication manner between the vehicle 100, the server 200, the ITS device 300 and another vehicle 400 and a user device is not limited to the example embodiment(s) disclosed herein.

FIG. 2 is a diagram illustrating example modules that constitute a vehicle.

The vehicle 100 may include a sensor unit (also referred to as sensor) 104, an operation unit (also referred to as user interface, human-machine interface, driver control, vehicle control, etc.) 106, a display 108, a load device 110, and a transceiver 112.

The sensor unit 104 may include various types of sensors for sensing various conditions and situations occurring in the external surrounding environment, internal systems, user operation, and boarding space of the vehicle 100.

Specifically, the sensor unit 104 may include an externally-oriented (e.g., outward-facing) image sensor 104a, a lidar sensor 104b, a radar sensor 104c, and the like to recognize dynamic and static objects existing around the vehicle 100.

The image sensor 104a may recognize an external object as an image during use of the vehicle 100, generate image data, and transmit the image data to a controller 120. The image sensor 104a may be installed in a plurality (e.g., serially, in a row, etc.) of parts of the vehicle 100 to acquire a plurality of images or multi-views of the surrounding environment of the vehicle 100.

The lidar sensor 104b may generate point cloud data about an object around the vehicle 100 and transmit the point cloud data to the controller 120. The point cloud data includes three-dimensional information of the object, and the point cloud data may also be referred to as lidar data in the present disclosure. In the present disclosure, it is illustrated that the lidar sensor 104b is mounted, but in other examples, the lidar sensor 102b may be omitted. The radar sensor 104c may generate lidar data via radio waves reflected from an external object by emitting electromagnetic waves of a specific frequency around the vehicle 100 in order to grasp the presence, relative distance, speed, direction, and the like of the external object. The radar data may be generated as point cloud data similar to the lidar data. A sensor that generates point cloud data may be illustrated as any one of the lidar sensor 104b and the radar sensor 104c. Although not shown in FIG. 2, the sensor unit 104 may include an ultrasonic sensor. The ultrasonic sensor may generate ultrasonic data including the distance and speed of a surrounding object based on ultrasonic waves emitted and reflected around the vehicle.

The sensor unit 104 may also include a positioning sensor 104d for checking the position of the vehicle 100. The positioning sensor 104d is, for example, a GPS sensor or a GNSS sensor, and is not limited thereto. In addition, the sensor unit 104 may include a posture sensor (not shown). The posture sensor may detect, for example, states of three axes of the vehicle 100, for example, yaw, pitch, and roll, and output various posture states of the vehicle based on the above-described factors. The posture sensor, for example, may include an IMU sensor, a gyro sensor, and the like.

The present disclosure mainly describes the sensors of the sensor unit 104 referred to in the description, and may further include sensors that sense various situations not listed therein.

The operation unit 106 may be configured as a module for a user to control for driving. For example, the operation unit 106 may include a steering wheel for manual driving, an automatic or manual transmission actuator, an accelerator pedal, a brake pedal, a gear transmission, or the like. The operation unit 106 further includes an interface for use, release, and selection of detailed functions of an autonomous driving mode requested by the user, so that the user uses the autonomous driving function. The operation unit 106 may be configured as, for example, a hard-type interface provided at a predetermined position inside the vehicle 100 or a soft-type interface touchable on the display 108, so as to receive various requests related to autonomous driving.

The display 108 may function as a user interface. The display 108 may display, by the processor 120, an operation state of the vehicle 100, a control state, path/traffic information, remaining energy information, content requested by a driver, and the like to be output. In addition, the display 108 may be configured as a touch screen capable of detecting driver input, and may receive a request of the driver instructing the processor 120.

The load device 110 is mounted on the vehicle 100, and may be a type of non-driving electric device excluding a driving power system such as a wheel driving unit (118). The load device 114 may be an auxiliary device that receives power from the power source unit 114, and may be, for example, an air conditioning system, an indicator lamp system, a lighting system, a seat system, and various devices installed in the vehicle 100.

The transceiver 112 may support mutual communication with the server 200, the ITS device 300, the surrounding vehicle 300, and the like. The transceiver 112 may include, for example, a module that processes cellular communication, WAVE, DSRC communication, or the like. In the present disclosure, the transceiver 112 may transmit data generated or stored during driving to the server 200, and receive data and a software module transmitted from the server 200. The transceiver 112 also may support communication with an electronic device carried by a passenger inside the vehicle 100. The vehicle 100 may transmit and receive data utilized in the method according to the present disclosure to and from the outside through the transceiver 112.

The vehicle 100 may also include the power source unit 114 and the actuating unit 116.

The power source unit 114 may generate and supply power and electric power to be used for a driving power system and a non-driving power system, such as the actuating unit 118. The non-driving power system may be, for example, but not limited to, the sensor unit 104, the operation unit 106, the display 108, the load device 110, the transceiver 112, and the like, and may include various components that implement sensing, interface, communication, and convenience functions except for components directly involved in a driving operation.

If the vehicle 100 is driven on an electric energy basis, the power source unit 114 may be configured with, for example, an electric battery that is charged from the outside, or may be configured with a combination of an electric battery and a fuel cell that charges the battery. In the case of a combination of the electric battery and the fuel cell, the power source unit 114 may include a tank that stores a material used to generate electric power of the fuel cell, such as liquefied hydrogen. If the vehicle 100 may be driven on a fossil energy basis, the power source unit 114 may include an internal combustion engine. Further, if the vehicle 100 is of a hybrid type, the power source unit 114 may be provided by a combination of the internal combustion engine and the electric battery.

The actuating unit 116 includes at least one module that implements a driving operation, and may perform at least one driving operation of a longitudinal control such as acceleration and deceleration, a transverse control such as steering, and a gear shift depending on a user request from the operation unit 106 or a request of the processor 120. Here, the gear shift may be processed by a request of a manual driving user using a gear transmission or the processor 120 in autonomous driving.

The actuating unit 116 may include a wheel driving unit (not shown), a mechanical component and an electronic module for implementing a driving operation on the wheel driving unit, so as to implement a driving operation depending on a command of the processor 120 by a user's manual operation or autonomous driving. If the vehicle 100 is operated based on electric energy, it may include an assembly for transmitting a requested driving operation to the wheel driving unit 118. If the vehicle is operated based on fossil energy, the actuating unit 116 may include a transmission and a gear module for transmitting power of an internal combustion engine.

The wheel driving unit may include a plurality of wheels, a driving force generation module for generating a driving force and applying it to the wheels or transmitting the driving force, a braking module for decelerating driving of the wheels, and a steering module for realizing transverse control of the wheels. If the vehicle 100 is driven based on electric energy, the driving force generation module may be configured as a motor assembly that generates a driving force based on power output from an electric battery. The braking module of the electric-based vehicle 100 may further have a regenerative braking function.

Additionally, the vehicle 100 may include a memory 118 and the processor 120.

The memory 118 may store applications and various data for control of the vehicle 100 to load the applications or read and write the data at the request of the processor 120. In the present disclosure, the memory 118 may include an application that recognizes an irregular static object on a road to identify a road boundary and a drivable area. The irregular static object may be a static object that may not identify a function or attribute by sensor-based object recognition that detects a surrounding environment. The irregular object may have a function collectively intended by a plurality of static objects arranged in succession on the road.

Although the type or class of a single static object detected by a sensor, e.g., the radar sensor 104c or the lidar sensor 104b, is defined by object recognition, the functionality collectively exhibited by multiple static objects, i.e., the functionality of an irregular object, may not be identified by object recognition. This may be due to the inability of object recognition to estimate the overall boundaries of multiple static objects.

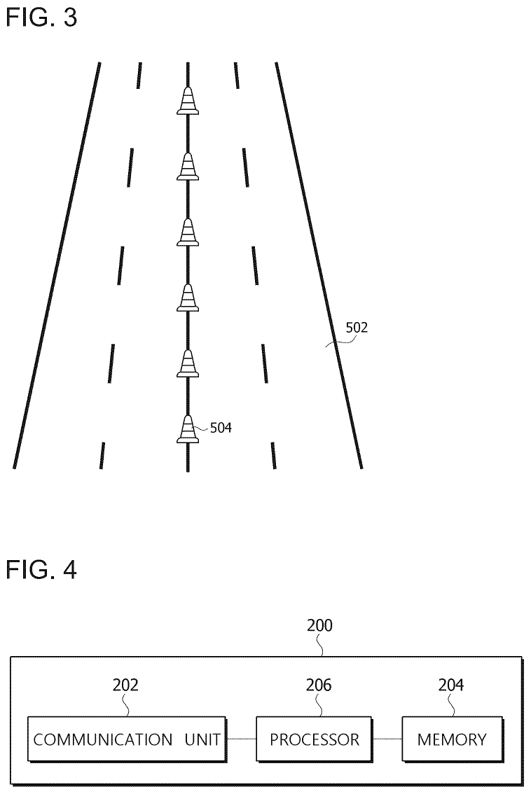

The irregular object may be a traffic safety facility 504 that is successively disposed on a road 502, as illustrated in FIG. 3. As used herein, the word “successive” or its derivative form may mean one or more of “spaced apart,” “evenly spaced,” “aligned or arrayed,” etc., especially along a straight or curved path or line. FIG. 3 is a diagram illustrating a illustrating traffic safety facility. The traffic safety facilities 504 may include, for example, facility guide rods, rubber cones, traffic barrels, curbs, and the like. Individual traffic safety facilities 504 illustrated in FIG. 3 may be defined by a type or class according to object recognition. Functions or attributes due to a plurality of traffic safety facilities 504 exemplified in FIG. 3 may be a road boundary that prohibit driving across potential lines according to successively arranged traffic safety facilities. Simple recognition processing of the radar sensor 104c or the lidar sensor 104b may not identify the functions of irregular objects such as the plurality of traffic safety facilities 504. In addition to the recognition processing of the sensors, the application of the present disclosure may recognize irregular static objects on the road, and identify road boundaries and drivable areas.

The memory 118 may store various information and data for object recognition. For example, the memory 118 may include a database used to generate information of an object detected by the image sensor 104a, the lidar sensor 104b, and the radar sensor 104c. The database may manage information including a type (or class) of the object and detailed data of the object.

The processor 120 may perform overall control of the vehicle 100. The processor 120 may be configured to execute applications and instructions stored in the memory 118. The processor 120 may generate a control instruction for a component of the vehicle 100 depending on a driving control request in manual driving and autonomous driving. The component may be at least one of various members described in FIG. 2.

The processor 120 may execute various processing for identifying a road boundary based on recognition of an irregular static object according to the present disclosure.

In an example, the processor 120 may execute processing of generating tracked positions (also variously referred to as tracked locations, tracked areas, tracked regions, track positions, track locations, track areas, track regions, tracking positions, tracking locations, tracking areas, tracking regions, etc.) of static objects arranged in a plurality (e.g., serially, in a row, etc.) based on sensor data of a sensor that generates point cloud data. The processor 120 may perform processing of providing a prediction range away from a preceding tracked position. Further, the processor 120 may perform processing of including a following tracked position (also referred to as next tracked position, succeeding tracked position, subsequent tracked position, etc.) in a tracking list (also referred to as track list or list of tracked positions) based on detection in the prediction range of the following tracked position. The processor 120 may execute, based on the tracking list including a threshold number (e.g., quantity) or more of tracked positions, processing of generating (e.g., identifying, recognizing, etc.) a road boundary object that classifies the tracked positions as a successive static object. For example, the processor 120 may, based on the tracking list including at least the threshold quantity of tracked positions, identify (e.g., classify) the tracked positions as a road boundary that includes (e.g., is made up of) successive (e.g., serially arranged) static objects.

The static object is a targeted stationary object, and may include an object related to a traffic safety facility, as described above. The sensor that generates point cloud data may include, for example, at least one of the radar sensor 104c and the lidar sensor 104b. The tracking area may be an area for tracking the static object generated from the point cloud data using a specific model. The tracked static object is provided for each single object, and a tracking identifier (also referred to as a track identifier) may be given for each tracked location. The tracked position may be data constituting tracking information. The tracking information may include, for instance, a tracking identifier, a tracked position, a position of an object belonging to the area, a distance of the object, a speed of the object, a direction of the object, and the like. The tracking information may be used to predict a state of subsequent tracking information and associate the acquired subsequent tracking information.

The tracking information may be generated in a space of the sensor that generates the tracked position or a fusion space by fusion of at least two sensors of the image sensor 104a, the lidar sensor 104b, and the radar sensor 104c. The tracking information of the fusion space may be configured with sensor-specific data or data estimated by sensor fusion. In this disclosure, although the space in which the tracked position is generated is described without specifying, the tracked position exemplified in the present disclosure may be provided in any space.

In another example, the processor 120 may execute a process of generating tracked positions of static objects arranged in a plurality (e.g., serially, in a row, etc.) based on sensor data of a sensor that generates point cloud data. The processor 120 may perform a process of generating linear information including a linear model based on an association (e.g., spatial relationship) between a leading tracked position and a trailing tracked position among the evaluation number or more of tracked positions. The leading tracked position may refer to the very first (e.g., foremost, initial) tracked position of an entire group of tracked positions, or alternatively refer to a tracked position that immediately precedes a specific tracked position (e.g., intermediate tracked position). The trailing tracked position may refer to the very last (e.g., rearmost, ultimate) tracked position of the entire group of tracked positions, or alternatively refer to a tracked position that immediately follows a specific tracked position (e.g., intermediate tracked position). In addition, the processor 120 may perform a process of determining whether an intermediate (e.g., intervening) tracked position exists in an association range (e.g., within a threshold distance) with the linear model, and sensor characteristics of the plurality of tracked positions have similarity. The processor 120 may execute a process of, in response to the existence in the association range and the similarity of the sensor characteristics, generating a road boundary object that classifies the plurality of tracked position as a successive static object. Sensor and tracked positions in other examples may be substantially the same as described in one example.

A detailed description of examples of processing by the processor 120 will be given below, and processing according to one example and another example may be performed to be compatible with the present disclosure.

The processor 120 is exemplified as being configured as a single processing module, as in FIG. 2, to execute the above processing. In another example, the processor 120 may be configured as a plurality of processing modules, so that the above processing is distributed and processed in the plurality of modules.

FIG. 4 is a diagram illustrating example modules that constitute a server.

The server 200 may transmit response data according to a request of the vehicle 100 to the vehicle 100, and may transmit an application built in the vehicle 100 and information for supporting vehicle driving to the vehicle 100. The server 200 may include a communication unit 202, a memory 204, and a processor 206.

The communication unit 202 may transmit and receive data to and from an external device, support mutual communication with the vehicle 100 in the present disclosure, and exchange data with the vehicle 100.

The memory 204 may store a program for operating the server 200 and various data, and load the program or read and write the data according to a request of the processor 206. The memory 204 may hold and manage a program for processing a request of the vehicle 100, an application built in the vehicle 100, and information for driving support. For example, the memory 204 may store a database, a high-precision map, and external information used to identify objects detected by the image sensor 104a, the lidar sensor 104b, and the radar sensor 104c.

The processor 206 may perform overall control of the server 200. The server 200 may be configured to execute a program and instructions stored in the memory 204. The processor 206 executes the program to process and respond to a user's request transmitted from the vehicle 100. For example, the processor 206 may transmit a database, a high-precision map, and external information used to identify an object detected by sensors that recognize the surrounding environment of the vehicle 100 according to the request of the vehicle 100.

The processor 206 is exemplified in the present disclosure as being configured as a single processing module. In another example, the processor 206 may be distributed to a plurality of processing modules, and the above processing may be executed by a distributed processing model.

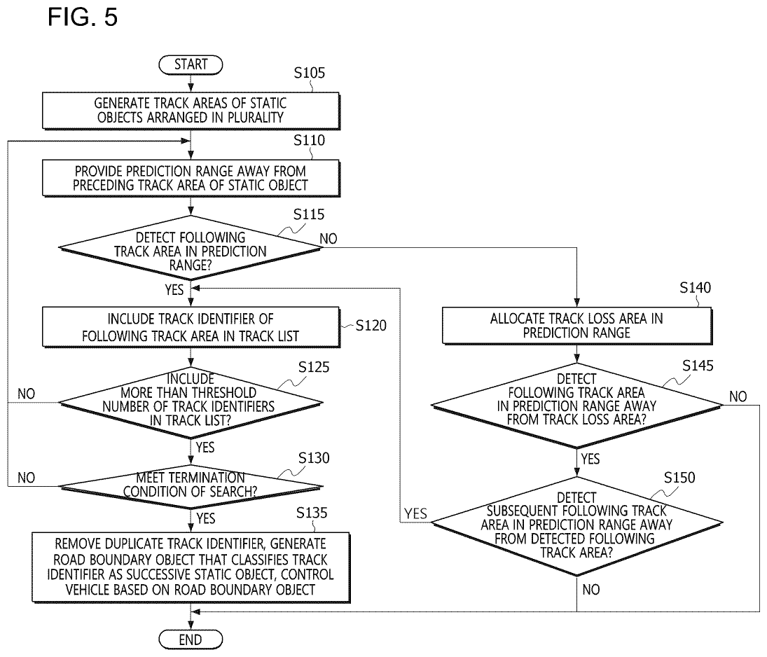

Hereinafter, another method for recognizing an irregular static object for identification of a road boundary will be described in detail with reference to FIG. 5. FIG. 5 is a flowchart of an example method for recognizing an irregular static object for identification of a road boundary.

In the present disclosure, a sensor that generates point cloud data includes at least one of the radar sensor 104c and the lidar sensor 104b, but for convenience of description, the sensor may be described as a sensor or a point cloud sensor without distinguishing the type of sensor. If there is a matter related to the image sensor 104a, it may be described as the image sensor 104a to be distinguished from other sensors. The method of the present disclosure is performed by the processor 120, but for convenience, the processor 120 and the vehicle 100 may be described in combination.

Referring to FIG. 5, the processor 120 of the vehicle 100 may generate tracked positions including a plurality of static objects of a road detected by the sensors 104b, 104c that generate point cloud data (S105).

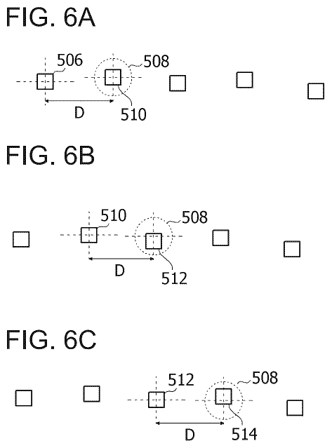

The tracked position may be generated for each static object and dynamic object on the road. In the case of a static object, the tracked position may be generated to include each traffic safety facility, as illustrated in FIGS. 6-8 and 10. The tracked position may, for example, be generated by a learning-based object recognition model. The tracked position is included in the tracking information described above, and a tracking identifier may be assigned for each tracked position. The tracked position may be generated in a predetermined space, for example, in a space of a point cloud sensor or a fusion space.

The processor 120 may adopt a homogeneous static object successively arranged on the road as the target object. The successively arranged static object may be, for example, a traffic safety facility. A detailed description of the traffic safety facility will be omitted as it is described in FIG. 2 and FIG. 3. A successive static object tracked position may be disposed along the driving direction, for example. In the present disclosure, for convenience of description, a tracked position positioned relatively ahead with respect to the driving direction or the arrangement direction of the tracked position may be referred to as a preceding tracked position, to distinguish from a tracked position positioned relative behind. Accordingly, the tracked position positioned behind may be referred to a following tracked position.

The processor 120 may provide a prediction range away from the preceding tracked position to the space (S110).

Referring to FIG. 6A related to an example of the prediction range, the prediction range may be generated to include an enclosed area 508 disposed at a distance D away from a preceding tracked position 506. The prediction range may be an area in which the next tracked position (e.g., the next tracked position immediately after the preceding tracked position 506) is expected (e.g., predicted) to be located based on one or more preceding tracked positions. The prediction range may have a predetermined dimension (e.g., radius, length, width, etc.). FIGS. 6A, 6B, and 6C are diagrams illustrating examples of a search for a tracked position. The direction in which the distance D is generated and the enclosed area 508 may be determined based on, for example, the driving direction of the vehicle 100 or the arrangement direction of the preceding tracked position and the following tracked position confirmed by object recognition. FIGS. 6A to 6C illustrate that a plurality of static objects are arranged in a straight line. The distance D may be set with reference to, for example, an average arrangement interval of traffic safety facilities arranged in a straight line. For example, the size of the enclosed area 506 may be set based on the separation position of the following tracked position (or the following traffic safety facility) allowed to the end of the distance D.

FIGS. 6B and 6C illustrate the enclosed area 508 of the prediction range provided if the following tracked position 512 and the subsequent following tracked position 514 shown in FIGS. 6A and 6B, respectively, belong to the enclosed area 508 of the prediction range. The prediction range generated based on the following tracked positions 512 and 514 may be provided by applying the same distance D applied to the prediction range generated based upon the preceding tracked position 506 and the size of the enclosed area 508.

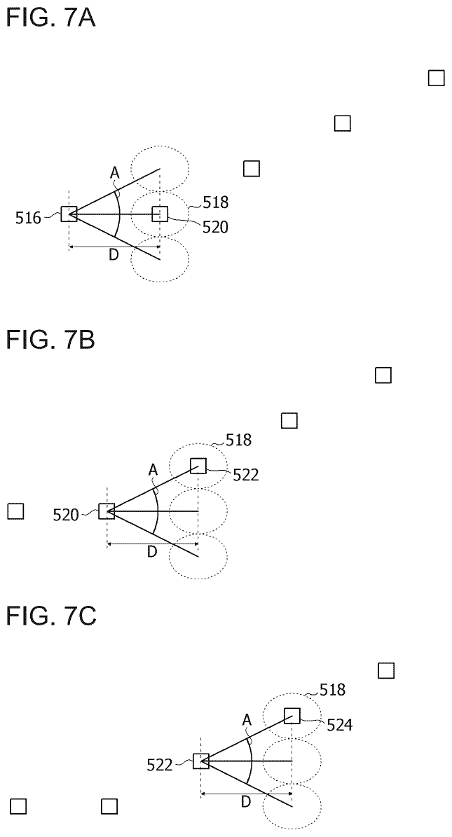

Referring to FIG. 7A related to another example of the prediction range, the prediction range may include an enclosed area 518 spaced apart from a preceding tracked position 516 by a distance D in the range of the allowable (e.g., acceptable) angle A. In other words, the enclosed area 518 may be positioned at an angle, relative to the preceding tracked position 516 (e.g., a direction of a path along which one or more preceding tracked positions are located), within a predetermined angular range (e.g., angle A). FIGS. 7A, 7B, and 7C are diagrams illustrating examples of the search for the tracked position.

FIGS. 7A to 7C illustrate that a plurality of static objects are arranged in a curved shape. An allowable (e.g., acceptable) angle A (e.g., angular range A) may be set to a predetermined angle range based on the arrangement direction of the preceding tracked position 516 and a following tracked position 520. For example, the allowable angle A may be set based on an average separation angle between traffic safety facilities arranged in a curved form. As another example, the allowable angle A may be set based on a curved shape or a curvature in an area of map information corresponding to positions of a plurality of traffic safety facilities. Similar to FIG. 6, the distance D may be set with reference to the average arrangement interval of the traffic safety facilities. Like FIG. 6, a size of the enclosed area 518 may be set based on the allowable separation position of the following tracked position or the following traffic safety facility that is allowed as an end of the distance D.

FIGS. 7B and 7C illustrate an enclosed area 518 of the prediction range provided if following tracked positions 520, 522 and subsequent following tracked positions 522, 524 shown in FIGS. 7A and 7B, respectively, belong to the enclosed area 518 of the prediction range. The prediction range generated based on the following tracked positions 520, 522, 524 may be provided by applying the same allowable angle A, distance D, and size of the enclosed area 516 applied to the prediction range generated based on the preceding tracked position 506.

Referring back to FIG. 5, the processor 120 may determine whether the following tracked position is detected in the prediction range (S115).

FIG. 6A relating to detection of a candidate tracked position illustrates that a following (e.g., next) tracked position 510 is determined to belong to the enclosed area 508 of the prediction range. FIGS. 6B and 6C illustrate the detection in the enclosed area 508 of the following tracked position performed if the following tracked positions 512 and the subsequent following tracked position 514 shown in FIGS. 6A and 6B, respectively, are arranged within the enclosed area 508.

FIG. 7A relating to detection of a candidate tracked position illustrates that the following tracked position 520 is determined to be located in the enclosed area 518 of the prediction range. FIGS. 7B and 7C illustrate the detection in the enclosed area 518 of the following tracked position performed if the following tracked positions 520 and the subsequent following tracked positions 522 shown in FIGS. 7A and 7B, respectively, are located in the enclosed areas 518.

Referring back to FIG. 5, if the following tracked position is detected in the prediction range, the processor 120 may include a tracking identifier of the following tracked position in a tracking list (S120).

According to the example of FIG. 6A, a tracking identifier of the following tracked position 510 detected in the enclosed area 508 of the prediction range may be registered in the tracking list together with a tracking identifier of the preceding tracked position 506. According to the example in FIG. 7A, a tracking identification of the following tracked position 520 detected in the enclosed area 518 of the prediction range may be registered in the tracking list together with a tracking identifier of the preceding tracked position 516. The tracking identifiers of the preceding tracked positions 506 and 516 may be registered in tracking lists in step S110 or step S120.

The processor 120 may determine whether the tracking list includes tracking identifiers of more than a threshold number of tracked positions (S125).

In order to identify the functions of a plurality of static objects, for example road boundary functions, a threshold number may be set to, for example, three or more. The threshold number may be the number required to identify the functions of the irregular objects.

If the tracking list does not include more than the threshold number of tracking identifiers, the processor 120 may perform the processes from step S110 to step S120. According to the example of FIG. 6A, the preceding tracked position 506 and the following tracked position 510 are registered in the tracking list, and thus the tracking list may have two tracking identifiers. In this case, the processor 120 may process the process from step S110 to step S120 related to the detection of the subsequent following tracked position 512 illustrated in FIG. 6B. According to the examples of FIG. 7A, the preceding tracked position 516 and the following tracked position 522 are registered in the tracking list, and thus, the tracking list may have two tracking identifiers. In such a case, the processor 120 may process the process from step S110 to step S120 related to detection of the subsequent following tracked position 522 illustrated in FIG. 7B.

In operation S125, if the tracking list includes a threshold number of tracking identifiers or more, the processor 120 may determine whether a termination condition of search related to detection of a subsequent tracked position is met (S130).

The termination condition of search may be a termination condition (“NO”) according to step S145 or step S150 described later. The termination condition according to step S145 may be that, after the allocation of a lost tracking area (also referred to as a track loss area) according to step S140, the following tracked position is not detected in the prediction range. The determination condition according to step S150 may be that the following tracked position has been detected in step S145, but the subsequent following tracked position is not detected in the prediction range. Thus, for example, if no tracked position is detected within a first prediction range (S115: “NO”) but tracked positions are respectively detected in a second prediction range (S145: “YES”) and a third prediction range (S150: “YES”), then the respective tracked positions in the second prediction range and the third prediction range may be added to the tracking list (S120), where the first, second, and third prediction ranges are consecutive prediction ranges that are spaced apart from each other (e.g., arranged at an interval).

If there is a subsequent following tracked position, or a termination condition of search is not met, the processor 120 may perform the processes from step S110 to step S130.

As illustrated in FIG. 6C, the processor 120 may process a process from step S110 to step S130 related to detection of the subsequent following tracked position 514. As illustrated in FIG. 7C, the processor 120 may process a process from step S110 to step S130 related to detection the subsequent following tracked position 524.

In operation S130, if the termination condition of search is met, the processor 120 may remove the tracking identifiers of the duplicate tracked position from the plurality of accumulated tracking lists, generate a road boundary object that classifies the remaining tracking identifiers as successive static objects, and control the vehicle 100 based on the road boundary object (S135).

As illustrated in FIG. 6 and FIG. 7, the detection of the tracked positions in the prediction range may be sequentially (e.g., repeatedly) performed for each tracked position of a plurality of tracked positions, and the tracking list may have a threshold number or more of tracking identifiers. Therefore, a following tracking identifier of the tracking list generated first may be the same as a preceding tracking identifier of the subsequently generated tracking list. The processor 120 may check the tracking identifier of each tracking list, so as to retain one tracking identifier, and remove duplicate tracking identifiers.

The processor 120 may group the remaining tracking identifiers into successive static objects to generate road boundary objects as irregular static objects. The processor 120 may recognize a plurality of traffic safety facilities as road boundary objects and determine, based on the road boundary objects, a road boundary area and a drivable area of the road. The processor 120, based on the tracking identifiers, may generate a boundary line connecting the successive static objects or a boundary area including all of the static objects. The road boundary objects may be generated to include the boundary line or the boundary area, along with the tracking identifiers. The processor 120 may control the driving of the vehicle 100 based on the road border areas and the drivable areas estimated from the plurality of traffic safety facilities by the road boundary objects. For example, the processor 120 may control the autonomous driving of the vehicle 100 based on the road border areas and the drivable areas estimated by the road boundary objects.

On the other hand, referring to FIG. 5, if the following tracked position is not detected in the prediction range away from the preceding tracked position in step S115, the processor 120 may allocate a lost tracking area 530 for estimating the loss of the static object to the prediction range (S140).

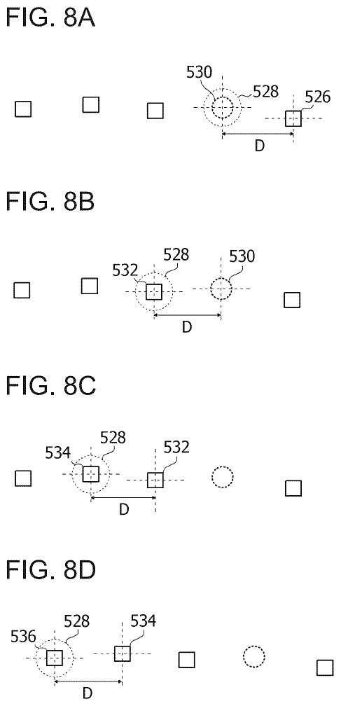

As illustrated in FIG. 8A, a following tracked position may not be detected in the enclosed area 528 of the predicted range that is spaced apart from the preceding tracked position 526. FIGS. 8A, 8B, 8C, and 8D are diagrams illustrating examples of the search for the tracked position. FIG. 8 illustrates that a plurality of static objects, e.g., a plurality of traffic safety facilities, are arranged in a different direction than FIGS. 6 and 7, such that tracked positions may also be generated in a different direction from FIGS. 6 and 7. FIG. 8 shows that the tracked positions are arranged in a straight line, and if the tracked positions are arrayed in a curved line, the predicted range may include the enclosed area based on the allowed angle and distance, as illustrated in FIG. 7.

Non-detection of the following tracked position may be due to, for example, the tracked position of the traffic safety facility not being generated due to loss or damage to the traffic safety facility. If no following tracked position (e.g., no additional tracked position) is detected, the processor 120 may assign a lost tracking area 530 to the enclosed area 528 of the predicted range, as illustrated in FIG. 8A.

Referring back to FIG. 5, the processor 120 may determine whether to detect a following tracked position in a prediction range away from the lost tracking area 530 (S145).

As illustrated in FIG. 8B, the processor 120 may identify whether a following tracked position 532 exists in the enclosed area 528 of the prediction range spaced apart from the lost tracking area 530 by the distance D.

Referring to FIG. 5, if the following tracked position 532 is detected, the processor 120 may determine whether to detect a subsequent following tracked position 534 in the enclosed area 528 of the prediction range away from the detected following tracked position 532, as illustrated in FIG. 8C (S150).

If the subsequent following tracked position 534 is detected, the processor 120 may proceed to step S120 to include the following tracked position 532 and the subsequent following tracked position 534 in the tracking list.

On the other hand, if the following tracked position is not detected in the prediction range in step S145 or the subsequent following tracked position in step S150 is not detected in the predicted range, the processor 120 may determine that the termination condition of search according to step S130 is met. If the search or detection of the tracked positions is terminated, the processor 120 may classify the preceding tracked position, the following tracked position, and the subsequent following tracked position into non-successive static objects. The non-continual static object may mean an object that does not have a function due to the aggregation of each tracked position, for example, a road boundary function. A space between each tracked position of the non-successive static object may not be recognized as a road boundary, but may be recognized as another region, for example a drivable region, or the like.

The search manners of the tracked positions in FIG. 6 and FIG. 7 described above are compatible in a technically non-conflicting range, and the prediction range for the search may be set in various manners.

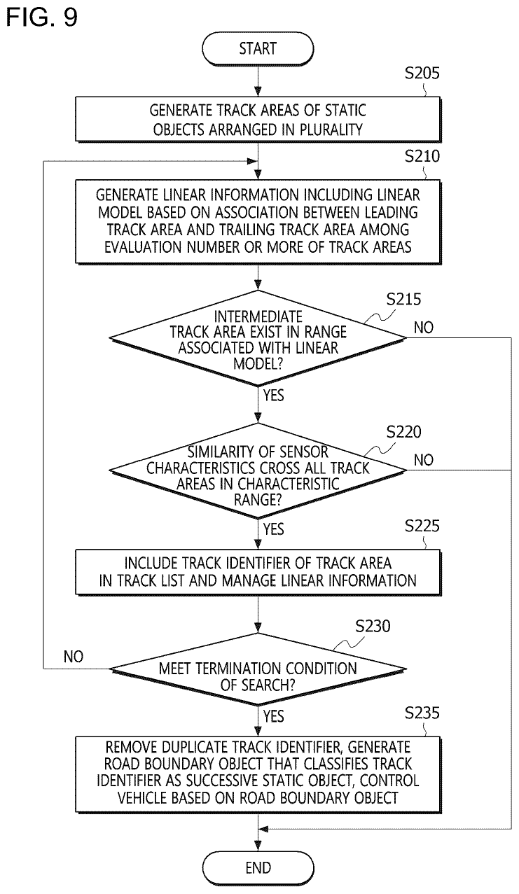

Hereinafter, another method of recognizing an irregular static object for identification of a road boundary will be described in detail with reference to FIG. 9. FIG. 9 is a flowchart of an example method for recognizing an irregular static object for identification of a road boundary. The example illustrated in FIG. 9 may be used for a tracked position (or a traffic safety facility) arranged in an irregular shape compared to FIGS. 6 to 8.

The processor 120 of the vehicle 100 may generate a tracked position including a plurality of static objects on the road detected by the sensors 104b and 104c that generate point cloud data (S205). This step may be substantially the same as step S105.

The processor 120 may generate linear information including a linear model based on an association between a leading tracked position and a trailing tracked position among the evaluation number or more of tracked positions (S210).

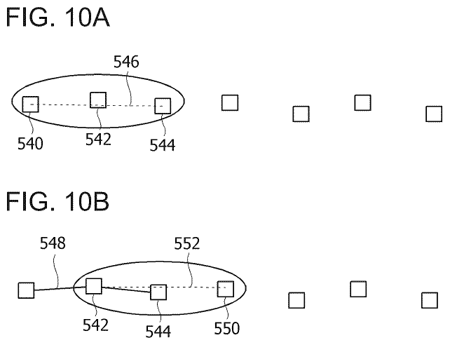

In order to identify a function of a plurality of static objects, for example, a road boundary function, the number of evaluations may be three or more. As illustrated in FIG. 10A, the number of the evaluations is set to three, and a linear model 546 may be generated based on an association between a leading tracked position 540 and a trailing tracked position 544. FIGS. 10A and 10B are diagrams illustrating examples of the search for the tracked position. The linear model 546 may be established as a linear function connecting the leading tracked position 530 and the trailing tracked position 544.

Referring to FIG. 9, the processor 120 may determine whether an intermediate tracked position exists in the range associated with the linear model 546 (S215).

As illustrated in FIG. 10A, if an intermediate (e.g., intervening) tracked position 542 between the leading tracked position 540 and the trailing tracked position 544 exists within a preset association range from the linear model 546 of the linear function (e.g., if the intermediate tracked position 542 has linear correlation above a threshold linear correlation value with respect to the leading tracked position 540 and the trailing tracked position 544), the processor 120 may determine that the intermediate tracked position 542 has proximity to the linear model 546.

Referring to FIG. 9, if the intermediate tracked position 542 exists in the range associated with the linear model 546, the processor 120 may determine whether the sensor characteristics of the plurality of tracked positions 540 to 544 have similarity within the characteristic range (S220).

The sensor may be the radar sensor 104c or the lidar sensor 104b, as described above. If the sensor associated with the tracked position is the radar sensor 104c, the sensor characteristic may include at least one of a signal-to-noise ratio (SNR) and a radar sensor reflected cross section (RCS). If the sensor is the lidar sensor 104b, a sensor characteristic may include an intensity of a reflected signal of a laser reflected from an object.

The tracking information related to each tracked position may further include a sensor characteristic. If the sensor characteristic according to the foregoing example provided by each tracking information falls within a preset characteristic range, the processor 120 may determine that the sensor characteristics of the plurality of tracked positions have similarity within the characteristic range.

If the sensor characteristics of the plurality of tracked positions are similar, the processor 120 may include the tracking identifier of each of the leading tracked position, the intermediate tracked position, and the following tracked position in the tracking list, and manage linear information, for example, a linear function model, in step S210 in association with the tracked positions in the list (S225).

The processor 120 may determine whether a termination condition of search related to a subsequent following tracked position is met (S230).

The termination condition of search may include, for example, that no following tracked position is present in the enclosed area of the distance and allowable angle range illustrated in FIGS. 6 and 7, or in an enclosed area based on a distance greater than the distance.

If the termination condition of search is not met, the processor 120 may perform the process from step S210 to step S230. As illustrated in FIG. 10B, the processor 120 may designate a leading tracked position and a trailing tracked position as a tracked position 542 and a tracked position 550, respectively, and repeat the process from S210 to S230 for the tracked positions 542, 544, and 550.

If the termination condition of search is met, the processor 120 may remove the tracking identifier of the duplicate tracked position from the plurality of accumulated tracking lists, generate a road boundary object that classifies the remaining tracking identifiers as successive static objects, and control the vehicle 100 based on the road boundary object (S235).

The road boundary object may be generated to include a boundary line 548 connecting the classified tracked position illustrated in FIG. 10B together with the classified tracking identifier. Step S235 may be substantially the same as step S135.

According to one aspect of the present disclosure, there is A method for recognizing an irregular static object for identification of a road boundary, the method comprising: generating track areas of static objects arranged in a plurality based on sensor data of a sensor that generates point cloud data; providing a prediction range spaced apart from a preceding track area; including, based on detection in the prediction range of a following track area, the following track area in a track list; and generating, based on the track list including at least a threshold number of track areas, a road boundary object that classifies the track areas as successive static objects.

In some implementations, the prediction range may comprise an enclosed area arranged at a distance away from the preceding track area.

In some implementations, the including the following track area in a track list may comprise including the following track area detected in the enclosed area in the track list.

In some implementations, the prediction range may include the enclosed area that is spaced apart from the preceding track area by the distance in the range of an allowable angle, and the allowable angle may be set to a predetermined range of angles based on an arrangement direction of the preceding track area and the following track area.

In some implementations, the threshold number may be set to three or more.

In some implementations, the providing a prediction range and the including the following track area in a track list may be performed sequentially for the plurality of track areas. Also, the generating a road boundary object may comprise: removing, based on the presence of a duplicate track area in the track list, the duplicate track area from the track list; and generating the road boundary object that classifies remaining track areas as the successive static objects.

In some implementations, the method may further comprise: after the providing a prediction range, assigning, based on non-detection in the prediction range of the following track area, a track loss area to the prediction range; determining whether to detect the following track area in a prediction range away from the track loss area; determining, based on the detection of the following track area, whether to detect a subsequent following track area in a prediction range away from the detected following track area; and including, based on the detection of the subsequent following track area, the following track area and the subsequent following track area in the track list.

In some implementations, the method may further comprise: classifying, based on the non-detection of the following track area in the prediction range or the non-detection of the subsequent following track area in the prediction range, the track area, the following track area, and the subsequent following track area as non-successive static objects.

In some implementations, the static object may comprise an object related to a traffic safety facility.

According to another aspect of the present disclosure, there is provided a method for recognizing an irregular static object for identification of a road boundary, the method comprising: generating track areas of static objects arranged in a plurality based on sensor data of a sensor that generates point cloud data; generating linear information including a linear model based on an association between a leading track area and a trailing track area among the evaluation number or more of track areas; and generating a road boundary object that classifies the plurality of track areas as successive static objects based on the intermediate track area being in an associated range with the linear model and the sensor characteristics of the plurality of track areas having a similarity.

In some implementations, the sensor may comprise a radar sensor or a lidar sensor, wherein the sensor characteristics of the radar sensor comprises at least one of a Signal-to-Noise Ratio (SNR) and a Radar Cross Section (RCS), and the sensor characteristics of the lidar sensor comprise an intensity of a reflected signal.

According to another aspect of the present disclosure, there is provided a vehicle for implementing recognition of an irregular static object for identification of a road boundary, the vehicle comprising: a sensor unit including a sensor that detects a surrounding environment with point cloud data; a memory storing at least one instruction; and at least one processor executing the at least one instruction stored in the memory. The at least one processor is configured to: generate track areas of static objects arranged in a plurality based on sensor data of the sensor; provide a prediction range spaced apart from a preceding track area; include, based on detection in the prediction range of a following track area, the following track area in a track list; and generate, based on the track list including at least a threshold number of track areas, a road boundary object that classifies the track areas as successive static objects.

The features briefly summarized above for this disclosure are only exemplary aspects of the detailed description of the disclosure which follow, and are not intended to limit the scope of the disclosure.

According to the present disclosure, it is possible to provide a method and vehicle for recognizing an irregular static object that accurately provides the road boundary by estimating a function on the road intended by the irregular static objects arranged successively.

Effects that may be obtained in the present disclosure are not limited to the above-mentioned effects, and other effects that are not mentioned will be clearly understood by those skilled in the art to which the present disclosure belongs from the description below.

While example embodiment(s)of the present disclosure described herein are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The example embodiment(s) of the present disclosure are not a list of all possible combinations and are intended to describe representative aspects of the present disclosure, and the matters described in the various example embodiments may be applied independently or in combination of two or more.

One or more example embodiments of the present disclosure, as disclosed herein, may be implemented with hardware, firmware, software, or any combination thereof. For example, the present disclosure may be implemented with application specific integrated circuits (ASICs), digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various example embodiment(s) to be executed on an apparatus or a computer, a non-transitory computer-readable medium having such software or commands stored thereon and executable on the apparatus or the computer.

What is claimed is:

1. A method performed by an apparatus of a vehicle, the method comprising:
generating, based on point cloud data generated by a sensor of the vehicle, a plurality of tracked positions of static objects that are arranged serially;
determining a prediction range that is spaced apart from a preceding tracked position of the plurality of tracked positions;
adding, based on detecting a next tracked position within the prediction range, the next tracked position to a tracking list;
identifying, based on the tracking list comprising at least a threshold quantity of tracked positions, the plurality of tracked positions as a road boundary comprising successive static objects; and
controlling, based on the identified road boundary, an autonomous driving operation of the vehicle.

2. The method of claim 1, wherein the prediction range comprises an enclosed area arranged at a distance away from the preceding tracked position.

3. The method of claim 2, wherein the adding of the next tracked position comprises:
adding, to the tracking list, the next tracked position that is detected in the enclosed area.

4. The method of claim 2, wherein the enclosed area is positioned at an angle, relative to the preceding track position, within a predetermined angular range, and
wherein the predetermined angular range is determined based on a direction in which the preceding tracked position and the next tracked position are arranged.

5. The method of claim 1, wherein the threshold quantity is at least three.

6. The method of claim 1, further comprising:
determining prediction ranges and adding next tracked positions repeatedly for a plurality of subsequent tracked positions, and
wherein the identifying of the plurality of tracked positions as the road boundary comprises:
removing, based on presence of a duplicate tracked position in the tracking list, the duplicate tracked position from the tracking list; and
identifying remaining tracked positions in the tracking list as the road boundary.

7. The method of claim 1, further comprising:
based on detecting no tracked position within a first prediction range and detecting respective tracked positions in a second prediction range and a third prediction range, adding, to the tracking list, the respective tracked positions in the second prediction range and the third prediction range, wherein the first prediction range, the second prediction range, and the third prediction range are consecutive prediction ranges that are spaced apart from each other.

8. The method of claim 1, further comprising:
based on detecting no tracked positions within three consecutive prediction ranges that are spaced apart from each other, classifying the three consecutive prediction ranges as non-successive static objects in the road boundary.

9. The method of claim 1, wherein the static objects comprise traffic safety equipment.

10. A method performed by an apparatus of a vehicle, the method comprising:
generating, based on point cloud data generated by a sensor of the vehicle, a plurality of tracked positions of static objects that are arranged serially;
generating, based on a spatial relationship between a leading tracked position and a trailing tracked position of the plurality of tracked positions, a linear model;
based on an intermediate tracked position having linear correlation above a threshold value, with respect to the leading tracked position and the trailing tracked position, and based on sensor characteristics of the plurality of tracked positions having at least a threshold similarity value, identifying, the plurality of tracked positions as a road boundary comprising successive static objects, wherein the intermediate tracked position is between the leading tracked position and the trailing tracked position; and
controlling, based on the identified road boundary, an autonomous driving operation of the vehicle.

11. The method of claim 10, wherein the sensor comprises at least one of: a radar sensor or a lidar sensor,
wherein the sensor characteristics associated with the radar sensor comprise at least one of: a signal-to-noise ratio or a radar cross section, and
wherein the sensor characteristics associated with the lidar sensor comprise an intensity of a reflected signal.

12. A vehicle comprising:
a sensor configured to generate, based on a surrounding environment of the vehicle, point cloud data;
a processor; and
a memory storing at least one instruction that is configured, when executed by the processor, to cause the vehicle to:
generate, based on the point cloud data, a plurality of tracked positions of static objects that are arranged serially;
determine a prediction range that is spaced apart from a preceding tracked position of the plurality of tracked positions;
add, based on detecting a next tracked position within the prediction range, the next tracked position to a tracking list;
identify, based on the tracking list comprising at least a threshold quantity of tracked positions, the plurality of tracked positions as a road boundary comprising successive static objects; and
control, based on the identified road boundary, an autonomous driving operation of the vehicle.

13. The vehicle of claim 12, wherein the prediction range comprises an enclosed area arranged at a distance away from the preceding tracked position.

14. The vehicle of claim 13, wherein the at least one instruction is configured, when executed by the processor, to cause the vehicle to add the next tracked position by:
adding, to the tracking list, the next tracked position that is detected in the enclosed area.

15. The vehicle of claim 13, wherein the enclosed area is positioned at an angle, relative to the preceding track position, within a predetermined angular range, and
wherein the predetermined angular range is determined based on a direction in which the preceding tracked position and the next tracked position are arranged.

16. The vehicle of claim 12, wherein the threshold quantity is at least three.

17. The vehicle of claim 12, wherein the at least one instruction is configured, when executed by the processor, to further cause the vehicle to determine prediction ranges and add next tracked positions repeatedly for a plurality of subsequent tracked positions, and
wherein the at least one instruction is configured, when executed by the processor, to cause the vehicle to identify the plurality of tracked positions as the road boundary by:
removing, based on presence of a duplicate tracked position in the tracking list, the duplicate tracked position from the tracking list; and
identifying remaining tracked positions in the tracking list as the road boundary.

18. The vehicle of claim 12, wherein the at least one instruction is configured, when executed by the processor, to further cause the vehicle to:
based on detecting no tracked position within a first prediction range and detecting respective tracked positions in a second prediction range and a third prediction range, add, to the tracking list, the respective tracked positions in the second prediction range and the third prediction range, and
wherein the first prediction range, the second prediction range, and the third prediction range are consecutive prediction ranges that are spaced apart from each other.

19. The vehicle of claim 12, wherein the at least one instruction is configured, when executed by the processor, to further cause the vehicle to:
based on detecting no tracked positions within three consecutive prediction ranges that are spaced apart from each other, classify the three consecutive prediction ranges as non-successive static objects in the road boundary.

20. The vehicle of claim 12, wherein the static objects comprise traffic safety equipment.
